(19) United States
(12) Patent Application Publication
(10) Pub. No.: US 2026/0328096 A1
(43) Pub. Date: Oct. 22, 2026

(54) BLADE FOR COMPRESSOR ASSEMBLY OF GAS TURBINE ENGINE

(71) Applicant: Solar Turbines Incorporated, San Diego, CA (US)

(72) Inventors: Timothy M. Hollman, San Diego, CA (US); Jiang Luo, San Diego, CA (US)

(73) Assignee: Solar Turbines Incorporated, San Diego, CA (US)

(21) Appl. No.: 19/180,313

(22) Filed: Apr. 16, 2025

(51) Int. Cl. F01D 5/14; F01D 21/00

(52) U.S. Cl. CPC F01D 5/141; F01D 21/003; F05D 2220/32; F05D 2240/30; F05D 2260/95; F05D 2260/96; F05D 2300/611

(57) ABSTRACT

A blade for a compressor assembly of a gas turbine engine includes an airfoil including a leading edge, a trailing edge, a suction surface, a pressure surface, a base, and a tip. The airfoil defines a chordal axis between the leading edge and the trailing edge, a span between the base and the tip, a chord length along the chordal axis which varies along the span, and a maximum thickness between the suction surface and the pressure surface which varies along the span. The chord length at one or more first locations of the airfoil is less than the chord length at the base. The maximum thickness at one or more second locations of the airfoil is greater than the maximum thickness at the tip. The one or more first locations and the one or more second locations are spaced apart from each other along the span.

### TECHNICAL FIELD

The present disclosure relates to a blade for a compressor assembly of a gas turbine engine, and more particularly to, a modal tuned blade for a compressor assembly of the gas turbine engine.

### BACKGROUND

A gas turbine engine may be used as a power source in various machines. The gas turbine engine includes a compressor to compress incoming air. The compressor includes a number of rotor and stator blades that work to increase the pressure, temperature, and density of the incoming air.

As the air passes through the compressor, it strikes the leading edge of the rotor and stator blades. However, constant strikes of the incoming air on the blade may cause a high-cycle fatigue (HCF) crack propagation, which may lead to a failure of the blade. The failure of a blade due to the crack propagation may significantly impact the performance and reliability of the compressor and may also incur additional replacement/maintenance costs. In some examples, the crack propagates from a mid-suction side surface of the blade. Further, it was observed that the crack propagation may be caused by surface or near surface forging defects, such as structural defects, internal defects, dimensional defects, or microstructural defects.

KR101346085B1 describes a design technique for a rotor blade of an axial-flow compressor. Although efforts have been made to improve manufacturing processes of compressor blades to overcome the issue of crack propagation, failures still occurred in the blades and further improvement is needed.

### SUMMARY

In an aspect of the present disclosure, a blade for a compressor of a gas turbine engine is provided. The blade includes an airfoil including a leading edge, a trailing edge, a suction surface, a pressure surface, a base, and a tip. The airfoil defines a chordal axis of the airfoil between the leading edge and the trailing edge. The airfoil also defines a span of the airfoil between the base and the tip. The airfoil further defines a chord length of the airfoil along the chordal axis. The chord length of the airfoil varies along the span of the airfoil. The chord length at one or more first locations of the airfoil is less than the chord length at the base of the airfoil. The one or more first locations of the airfoil are spaced apart from each other along the span of the airfoil. The airfoil defines a maximum thickness of the airfoil between the suction surface and the pressure surface. The maximum thickness of the airfoil varies along each of the span of the airfoil and the chordal axis of the airfoil. The maximum thickness at one or more second locations of the airfoil is greater than the maximum thickness defined at the tip of the airfoil. The one or more second locations of the airfoil are spaced apart from each other along the span of the airfoil.

In another aspect of the present disclosure, a compressor assembly for a gas turbine engine is provided. The compressor assembly includes a central hub. The compressor assembly also includes a plurality of blades coupled with and extending radially from the central hub. Each of the plurality of blades includes an airfoil including a leading edge, a trailing edge, a suction surface, a pressure surface, a base, and a tip. The airfoil defines a chordal axis of the airfoil of the airfoil between the leading edge and the trailing edge. The airfoil also defines a span of the airfoil between the base and the tip. The airfoil further defines a chord length along the chordal axis. The chord length of the airfoil varies along the span of the airfoil. The chord length at one or more first locations of the airfoil is less than the chord length at the base of the airfoil. The one or more first locations of the airfoil are spaced apart from each other along the span of the airfoil. The airfoil defines a maximum thickness of the airfoil between the suction surface and the pressure surface. The maximum thickness of the airfoil varies along each of the span of the airfoil and the chordal axis of the airfoil. The maximum thickness at one or more second locations of the airfoil is greater than a maximum thickness defined at the tip of the airfoil. The one or more second locations of the airfoil are spaced apart from each other along the span of the airfoil.

In yet another aspect of the present disclosure, a method of altering a modal response of a blade for a compressor assembly of a gas turbine engine is provided. The blade includes an airfoil. The airfoil includes a leading edge, a trailing edge, a suction surface, a pressure surface, a base, and a tip. The airfoil defines a chordal axis of the airfoil between the leading edge and the trailing edge, a span of the airfoil between the base and the tip, a chord length of the airfoil along the chordal axis, and a maximum thickness of the airfoil between the suction surface and the pressure surface. The method includes detecting a failure of the blade due to the modal response of the blade. The method also includes tuning the chord length of the airfoil. Based on the tuning of the chord length, the chord length varies along the span of the airfoil. Based on the tuning of the chord length, the chord length at one or more first locations of the airfoil is less than the chord length at the base of the airfoil. The one or more first locations of the airfoil are spaced apart from each other along the span of the airfoil. The method further includes tuning the maximum thickness of the airfoil. Based on the tuning of the maximum thickness, the maximum thickness varies along each of the span of the airfoil and the chordal axis of the airfoil. Based on the tuning of the maximum thickness, the maximum thickness at one or more second locations of the airfoil is greater than the maximum thickness defined at the tip of the airfoil. The one or more second locations of the airfoil are spaced apart from each other along the span of the airfoil. The method includes altering the modal response of the blade based on the tuning of the chord length and the maximum thickness.

Other features and aspects of this disclosure will be apparent from the following description and the accompanying drawings.

### BRIEF DESCRIPTION OF THE DRAWINGS

FIG. 1 is a schematic cross-sectional view of a gas turbine engine, according to an example of the present disclosure;

FIG. 2 is a schematic perspective view of a compressor assembly of the gas turbine engine of FIG. 1, according to an example of the present disclosure;

FIG. 3 is a perspective view of a blade of the compressor assembly of FIG. 2, according to an example of the present disclosure;

FIG. 4 is a schematic top view of an airfoil of the blade of FIG. 3;

FIG. 5 is a flowchart of a method of altering a modal response of the blade for the compressor assembly of the gas turbine engine of FIG. 1, according to an example of the present disclosure;

### DETAILED DESCRIPTION

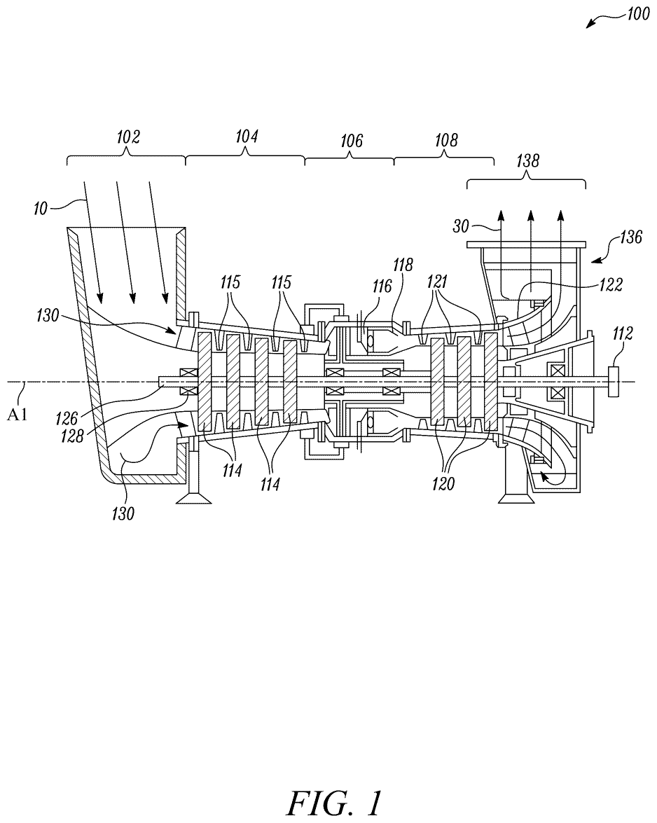

Referring to FIG. 1, a schematic cross-sectional view of a gas turbine engine 100 is illustrated. Some of the surfaces of the gas turbine engine 100 have been left out or exaggerated for clarity and ease of explanation. Also, the disclosure may reference a forward and an aft direction. Generally, all references to “forward” and “aft” are associated with a flow direction of primary air (i.e., the working fluid in combustion process), unless specified otherwise. For example, forward is “upstream” relative to primary air flow, and aft is “downstream” relative to primary air flow.

In addition, the disclosure may generally reference a center axis A1 of rotation of the gas turbine engine 100. The center axis A1 may be common to or shared with various other engine concentric components. All references to radial, axial, and circumferential directions and measures refer to the center axis A1, unless specified otherwise, and terms such as “inner” and “outer” generally indicate a lesser or greater radial distance from, wherein a radial direction may be in any direction perpendicular and radiating outward from the center axis A1.

The gas turbine engine 100 includes an inlet 102, a compressor 104, a combustor 106, a turbine 108, an exhaust system 138, and a power output coupling 112. The combustor 106 includes one or more fuel injectors 116 and one or more combustion chambers 118. The exhaust system 138 may include an exhaust diffuser 122, which diffuses exhaust 30, and an exhaust collector 136, which collects, redirects, and outputs exhaust 30. The gas turbine engine 100 also includes a shaft 126 supported by one or more bearing assemblies 128. The shaft 126 extends along the center axis A1.

An inlet 102 funnels a “working fluid,” into an annular flow path 130 into the compressor 104. While the working fluid will primarily be referred to herein as air 10, it should be understood that air 10 could comprise other fluids, including other gases.

The compressor 104 includes a series of compressor assemblies, including compressor rotor assemblies 114 and compressor stator assemblies 115. Each compressor rotor assembly 114 is separated, along the center axis A1, from the adjacent compressor rotor assembly 114 by a compressor stator assembly 115. The compressor 104 compresses the working fluid through a series of numbered stages corresponding to each compressor rotor assembly 114.

The air 10 leaving the compressor 104 enters the combustor 106, where the air 10 is diffused and fuel is added. In some examples, the fuel may include diesel, kerosene, and the like. In other examples, the fuel may include natural gas, hydrogen, refinery gas, syn gas, and the like. The fuel is injected into the one or more combustion chambers 118 via the one or more fuel injectors 116 and ignited to produce a combustion reaction in the one or more combustion chambers 118. The product of the combustion reaction drives the turbine 108.

The turbine 108 includes a series of turbine assemblies, including turbine rotor assemblies 120 and turbine stator assemblies 121. Each turbine rotor assembly 120 may correspond to one of a plurality or series of stages. The turbine 108 extracts energy from the combusting fuel-gas mixture as the mixture passes through each stage. The energy extracted by the turbine 108 may be transferred via a power output coupling 112 (e.g., to an external system), as well as to the compressor 104 via the shaft 126.

Exhaust gases 30 may then be diffused in the exhaust diffuser 122 after which the exhaust gases 30 may exit the gas turbine engine 100.

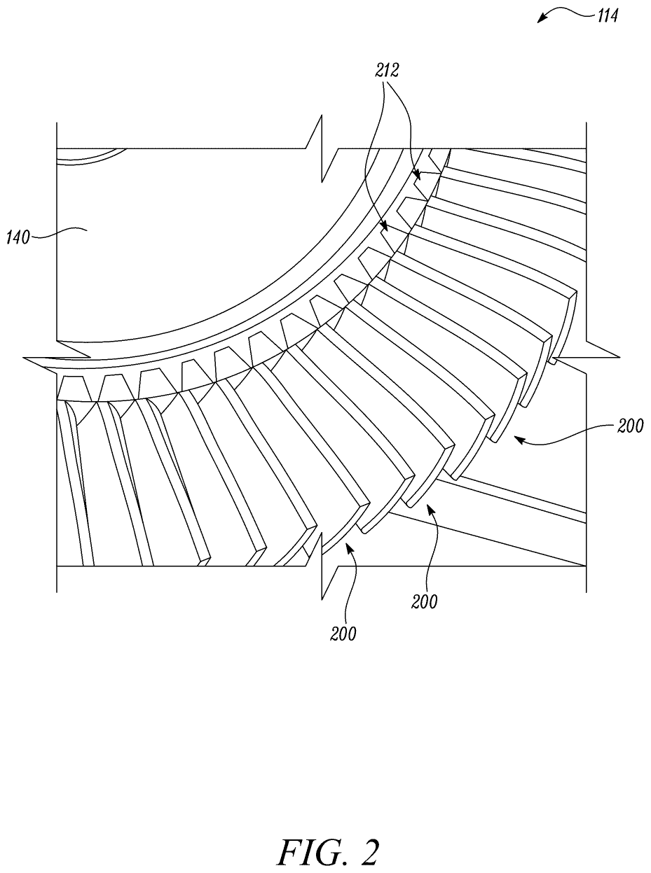

Referring to FIG. 2, a schematic perspective view of a single compressor assembly is illustrated. The compressor assembly shown in FIG. 2 is a compressor rotor assembly 114, however, a person of skill in the art would readily understand that the present disclosure may also be applied to a stator assembly of the compressor 104. The compressor assembly 114 includes a central hub 140. In FIG. 2, the central hub 140 is embodied as a rotor disk. The central hub 140 is a core structural and a fundamental element of the compressor assembly 114. The compressor assembly 114 also includes a number of blades 200 coupled with and extending radially from the central hub 140. Specifically, the compressor assembly 114 include the central hub 140 that is circumferentially populated with the blades 200. The central hub 140 connects the number of blades 200 of the compressor assembly 114 to the shaft 126.

In the illustrated embodiment of FIG. 2, each of the blades 200 is made of stainless steel. However, the blades 200 may be made of another metal, an alloy, a composite, or any other material, without limiting the scope of the present disclosure. Further, the blades 200 may include an anti-corrosion coating. In some examples, the blades 200 may include a ceramic coating, a polymeric coating, a powder coating, an epoxy coating, an electroplating, or a paint coating, without limiting the scope of the present disclosure.

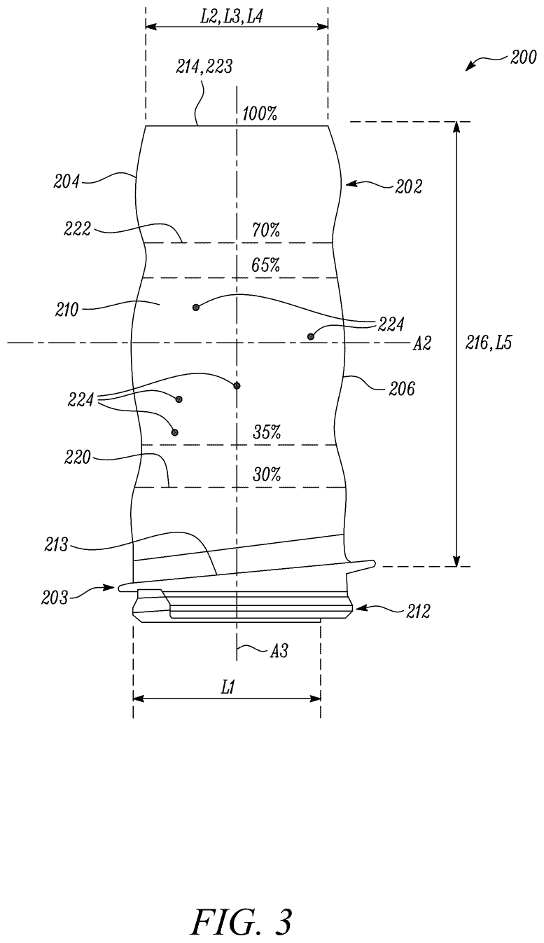

Referring now to FIG. 3, a single blade 200 is illustrated. However, the details provided herein are applicable to all other blades 200 associated with the compressor assembly 114 (see FIG. 2). In some examples, the blade 200 may be associated with a second stage compressor rotor assembly 114, without any limitations. Each blade 200 includes an airfoil 202, a platform 203, and a root 212. The airfoil 202 has a base 213 and a tip 214. The base 213 is the radially lowermost edge of the airfoil 202 that connects the airfoil 202 to the platform 203. The tip 214 is the radially outermost edge of the blade 200. The airfoil 202 has a cross-sectional shape designed to efficiently interact with the incoming air 10. The root 212 extends radially inward from the platform 203 and is configured to connect the blade 200 to the central hub 140 (see FIG. 2). The root 212 is the thickest part of the blade 200 and is designed to withstand high stresses and temperatures generated during operation. The root 212 transmits forces generated by the airfoil 202 to the central hub 140 which allows the blade 200 to rotate and compress the incoming air 10. As such the tip 214 and the root 212 are disposed at radially opposite ends of the blade 200.

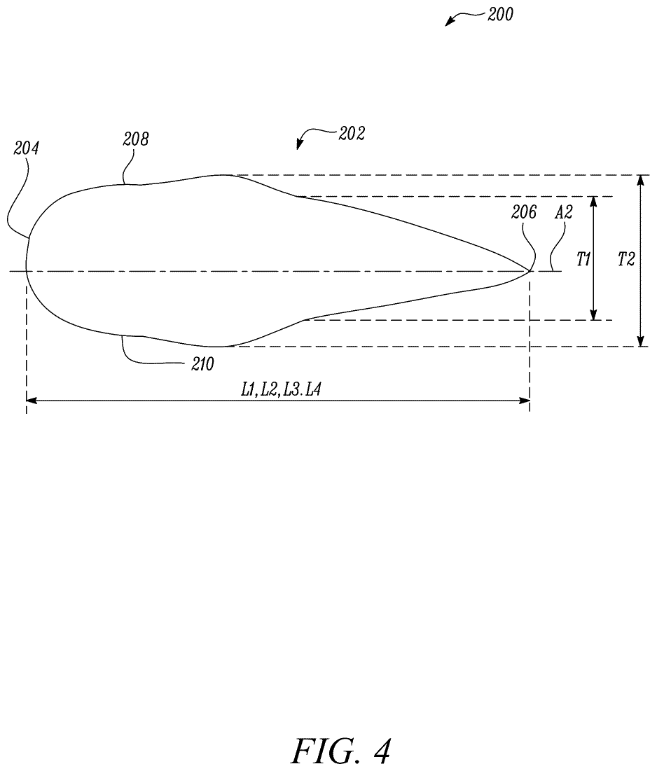

Referring now to FIG. 4, the airfoil 202 also includes a leading edge 204 and a trailing edge 206. The leading edge 204 is the forward-most point of the airfoil 202. The incoming air 10 (see FIG. 1) first encounters with the leading edge 204 of the airfoil 202. The trailing edge 206 is the rearmost part of the airfoil 202 where the incoming air 10 exits the blade 200. The airfoil 202 further includes a suction surface 208. The suction surface 208 increases a velocity of the incoming air 10 which results in a decrease in static pressure of the incoming air 10.

The airfoil 202 includes a pressure surface 210 opposite the suction surface 208. The pressure surface 210 experiences a high static pressure compared to the suction surface 208. The difference in the static pressures of the suction surface 208 and the pressure surface 210 is crucial for generating a lift force that propels the incoming air 10 through the compressor assembly 114 (see FIG. 2). In some examples, each of the suction surface 208 and the pressure surface 210 may have a curved profile. Alternatively, the suction surface 208 of the airfoil 202 may have a curved shape and the pressure surface 210 of the airfoil 202 may have a flat profile. However, the present disclosure is not limited to a general shape/profile of the airfoil 202.

Referring again to FIG. 3, the airfoil 202 defines a chordal axis A2 of the airfoil 202 between the leading edge 204 and the trailing edge 206. The airfoil 202 also defines a span 216 of the airfoil 202 between the base 213 and the tip 214. The span 216 defines a span length L5. The span length L5 is defined from the base 213 to the tip 214 along a stacking axis A3. The stacking axis A3 extends along the span 216 of the airfoil 202 and extends centrally relative to the leading edge 204 and the trailing edge 206.

The airfoil 202 further defines a chord length L1, L2, L3, L4 of the airfoil 202 along the chordal axis A2. The chord length L1, L2, L3, L4 of the airfoil 202 varies along the span 216 of the airfoil 202.

The chord length L2, L3, L4 at one or more first locations 220 of the airfoil 202 is less than the chord length L1 at the base 213 of the airfoil 202. The one or more first locations 220 of the airfoil 202 are spaced apart from each other along the span 216 of the airfoil 202. In general, the blade 200 may have a wavy profile along the leading edge 204 and the trailing edge 206 due to a variation in the chord length L1, L2, L3, L4 along the span 216 of the airfoil 202. In some examples, the chord lengths L2, L3 L4 may be the same. Alternatively, the chord lengths L2, L3 L4 may be the different from each other.

In some examples, the one or more first locations 220 includes three first locations 220, 222, 223. As an example, only three first locations 220, 222, 223 are shown in FIG. 3. However, the airfoil 202 may define multiple first locations at which the chord length L2, L3, L4 may vary, as per application attributes. The chord lengths L2, L3, L4 at the three first locations 220, 222, 223 of the airfoil 202 is less than the chord length L1 defined at the base 213 of the airfoil 202.

The three first locations 220, 222, 223 are defined in a region between 20% and 100% of the span length L5. In an example, the three first locations 220, 222, 223 are defined at 30%, 70%, and 100%, respectively, of the span length L5. Specifically, the first location 220 is defined at 30% of the span length L5, the first location 222 is defined at 70% of the span length L5, and the first location 223 is defined at 100% of the span length L5. The first location 223 is the tip 214 of the airfoil 202. The three first locations 220, 222, 223 and the chord lengths L2, L3, L4 at the three first locations 220, 222, 223 may be determined based on a test analysis that may be performed using various computational methods including, but not limited to, computational fluid dynamics analysis.

Referring now to FIGS. 3 and 4, the airfoil 202 defines a maximum thickness T1, T2 of the airfoil 202 between the suction surface 208 and the pressure surface 210. It should be noted that the airfoil 202 defines a number of maximum thicknesses (similar to the maximum thickness T2) at each section along the span 216. The maximum thickness T2 of the airfoil 202 varies along each of the span 216 of the airfoil 202 and the chordal axis A2 of the airfoil 202.

Further, the maximum thickness T1 is defined at the tip 214 of the airfoil 202. The maximum thickness T2 at one or more second locations 224 of the airfoil 202 is greater than the maximum thickness T1 at the tip 214 of the airfoil 202. In general, the blade 200 may have a bumpy texture due to a variation in the maximum thickness T1, T2 along the span 216 and the chordal axis A2. The one or more second locations 224 of the airfoil 202 are spaced apart from each other along the span 216 of the airfoil 202. The airfoil 202 may define multiple second locations 224 at which the maximum thickness T2 may vary, as per application attributes.

In some examples, the one or more second locations 224 may lie in a region between 35% and 65% of the span length L5. In some examples, the one or more second locations 224 may be defined in a region between 45% and 60% of the span length L5. The one or more second locations 224 and the maximum thickness T1, T2 may be determined based on a test analysis that may be performed using various computational methods including, but not limited to, computational fluid dynamics analysis.

In some examples, the maximum thickness T2 at the one or more second locations 224 is offset from the stacking axis A3 defined by the airfoil 202. However, in some examples, the maximum thickness T2 at the one or more second locations 224 may lie on the stacking axis A3.

In one example, the chord length L2, L3, L4 at the one or more first locations 220 and the maximum thickness T2 at the one or more second locations 224 are determined to move two or more modal responses of the blade 200 outside of a desired operating range of the gas turbine engine 100 (see FIG. 1). The modal response of the blade 200 may refer to a vibrational behavior of the blade 200 when subjected to an external force or an excitation. The modal response of the blade 200 may assist personnel to determine and ensure that the blade 200 is operating reliably and efficiently, without experiencing excessive vibrations that may lead to a fatigue failure. Various components disposed around the blade 200, that are also known as engine drivers, may influence the modal response of the blade 200. The key focus of the present disclosure is to move or separate modal responses with the engine drivers out of the desired operating range of the gas turbine engine 100.

Further, the two or more modal responses of the blade 200 are defined proximal to the desired operating range of the gas turbine engine 100.

In another example, the chord length L2, L3, L4 at the one or more first locations 220 and the maximum thickness T2 at the one or more second locations 224 are determined to maximize a separation of the two or more modal responses of the blade 200. It should be noted that the maximum thickness T1, T2 are merely a representative example.

It is to be understood that individual features shown or described for one embodiment may be combined with individual features shown or described for another embodiment. The above-described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

The present disclosure relates to the blade 200 for the compressor assembly 114. The blade 200 is made of stainless steel, which may increase an endurance limit of the blade 200. Moreover, the blade 200 made of stainless steel may be easy to machine and may allow for less part-to-part variability. The blade 200 includes the airfoil 202. The airfoil 202 includes the leading edge 204, the trailing edge 206, the suction surface 208, the pressure surface 210, the base 213, and the tip 214. The airfoil 202 defines the chordal axis A2 between the leading edge 204 and the trailing edge 206, the span 216 between the base 213 and the tip 214, the chord length L1, L2, L3, L4 along the chordal axis A2, and the maximum thickness T1, T2 between the suction surface 208 and the pressure surface 210.

Further, the chord length L1, L2, L3, L4 varies along the span 216 and the chord length L2, L3, L4 at the one or more first locations 220 of the airfoil 202 is less than the chord length L1 at the base 213 of the airfoil 202. Furthermore, the maximum thickness T2 varies along the span 216 and the maximum thickness T2 at the one or more second locations 224 of the airfoil 202 is greater than the maximum thickness T1 at the tip 214. The variation in the chord length L2, L3, L4 and the maximum thickness T2 along the span 216 of the airfoil 202 may lead to reduced crack propagation, optimized pressure distribution, optimized weight distribution, reduced stress concentration, adaptability to different airflow conditions, minimized noise generation, and the like. In some examples, the maximum thickness T2 at the one or more second locations 224 is tuned such that the maximum thickness T2 is offset from the stacking axis A3 so as to improve the modal response of the blade 200.

Furthermore, the variation in the chord lengths L2, L3, L4 and the maximum thicknesses T2 along the span 216 may diminish an effect of constant strikes of the incoming air 10 on the leading edge 204 and may reduce a probability of failure of the leading edge 204 by a high-cycle fatigue (HCF) crack propagation.

Moreover, the chord length L2, L3, L4 at the one or more first locations 220 and the maximum thickness T2 at the one or more second locations 224 are determined to move the two or more modal responses of the blade 200 outside of the desired operating range of the gas turbine engine 100 and to maximize the separation of the two or more modal responses of the blade 200.

The blade 200 has a unique chord length profile and a bumpy surface texture as a result of the tuning of the chord lengths L2, L3, L4 and the maximum thickness T2. Further, the tuning of the chord length L2, L3, L4 and the maximum thickness T2 may cause a movement or a separation of the modal responses with the engine drivers out of the desired operating range operating range of the gas turbine engine 100.

Overall, the blade 200 may be simple in construction, may be cost-effective, and may be durable. Further, the blade 200 may be retrofitted on existing compressor assemblies. Moreover, the blade 200 may be used on a variety of compressor assemblies.

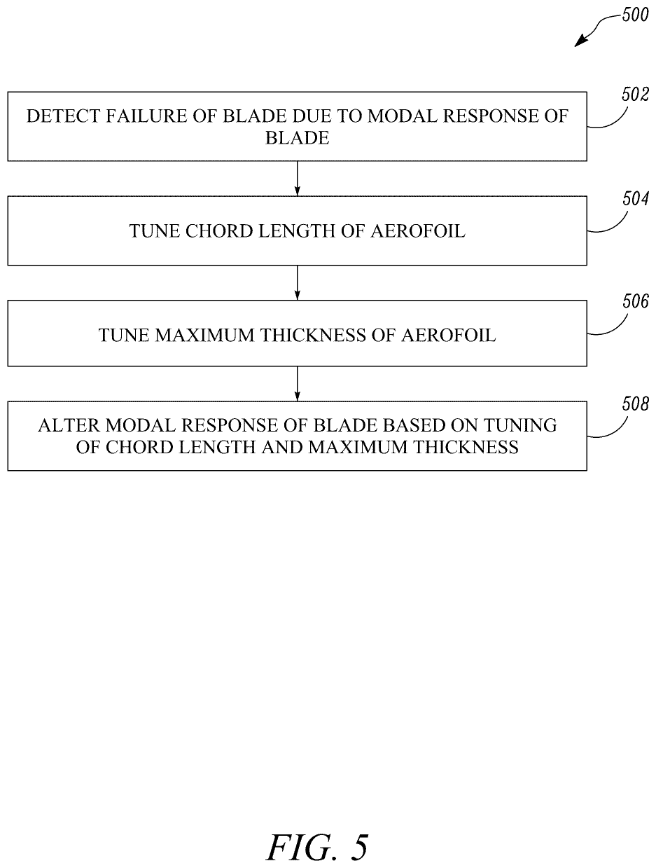

FIG. 5 is a flowchart for a method 500 of altering the modal response of the blade 200 for the compressor assembly 114 of the gas turbine engine 100. Referring to FIGS. 1 to 5, the blade 200 includes the airfoil 202 including the leading edge 204, the trailing edge 206, the suction surface 208, the pressure surface 210, the base 213, and the tip 214. The airfoil 202 defines the chordal axis A2 of the airfoil 202 between the leading edge 204 and the trailing edge 206, the span 216 of the airfoil 202 between the base 213 and the tip 214, the chord length L1, L2, L3, L4 of the airfoil 202 along the chordal axis A2, and the maximum thickness T1, T2 of the airfoil 202 between the suction surface 208 and the pressure surface 210.

At step 502, the failure of the blade 200 is detected due to the modal response of the blade 200.

At step 504, the chord length L2, L3, L4 of the airfoil 202 is tuned. The chord length L2, L3, L4 varies along the span 216 of the airfoil 202 based on the tuning of the chord length L2, L3, L4. The chord length L2, L3, L4 at the one or more first locations 220 of the airfoil 202 is less than the chord length L1 at the base 213 of the airfoil 202 based on the tuning of the chord length L2, L3, L4. The one or more first locations 220 of the airfoil 202 are spaced apart from each other along the span 216 of the airfoil 202.

In some examples, the chord lengths L2, L3, L4 at the three first locations 220, 222, 223 of the airfoil 202 is tuned, such that the chord length L2, L3, L4 at the three first locations 220, 222, 223 is less than the chord length L1 at the base 213 of the airfoil 202. The three first locations 220, 222, 223 are defined in the region between 20% and 100% of the span length L5 of the span 216. The span length L5 is defined from the base 213 to the tip 214 along the stacking axis A3.

At step 506, the maximum thickness T2 of the airfoil 202 is tuned. The maximum thickness T2 varies along each of the span 216 of the airfoil 202 and the chordal axis A2 of the airfoil 202 based on the tuning of the maximum thickness T2. The maximum thickness T2 at the one or more second locations 224 of the airfoil 202 is greater than the maximum thickness T1 at the tip 214 of the airfoil 202 based on the tuning of the maximum thickness T2. The one or more second locations 224 of the airfoil 202 are spaced apart from each other along the span 216 of the airfoil 202.

At step 508, the modal response of the blade 200 is altered based on the tuning of the chord length L2, L3, L4 and the maximum thickness T2.

The method 500 further includes a step (not shown) at which the chord length L2, L3, L4 at the one or more first locations 220 and the maximum thickness T2 at the one or more second locations 224 is determined to move the two or more modal responses of the blade 200 outside of the desired operating range of the gas turbine engine 100.

The method 500 further includes a step (not shown) at which the chord length L2, L3, L4 at the one or more first locations 220 and the maximum thickness T2 at the one or more second locations 224 is determined to maximize the separation of the two or more modal responses of the blade 200. The two or more modal responses of the blade 200 are defined proximal to the desired operating range of the gas turbine engine 100.

It should be noted that the steps 502, 504, 506, 508 of the method 500 may be performed in a sequence that is different from that explained in relation to FIG. 5. Further, various steps 502, 504, 506, 508 can be performed together.

While aspects of the present disclosure have been particularly shown and described with reference to the embodiments above, it will be understood by those skilled in the art that various additional embodiments may be contemplated by the modification of the disclosed work machine, systems, and methods without departing from the spirit and scope of the disclosure. Such embodiments should be understood to fall within the scope of the present disclosure as determined based upon the claims and any equivalents thereof.

1. A blade for a compressor assembly of a gas turbine engine, the blade comprising:
an airfoil including a leading edge, a trailing edge, a suction surface, a pressure surface, a base, and a tip, wherein the airfoil defines:
a chordal axis of the airfoil between the leading edge and the trailing edge;
a span of the airfoil between the base and the tip;
a chord length of the airfoil along the chordal axis, wherein the chord length of the airfoil varies along the span of the airfoil, wherein the chord length at one or more first locations of the airfoil is less than the chord length defined at the base of the airfoil, and wherein the one or more first locations of the airfoil are spaced apart from each other along the span of the airfoil; and
a maximum thickness of the airfoil between the suction surface and the pressure surface, wherein the maximum thickness of the airfoil varies along each of the span of the airfoil and the chordal axis of the airfoil, wherein the maximum thickness at one or more second locations of the airfoil is greater than the maximum thickness defined at the tip of the airfoil, and wherein the one or more second locations of the airfoil are spaced apart from each other along the span of the airfoil.

2. The blade of claim 1, wherein the chord lengths at three first locations of the airfoil is less than the chord length defined at the base of the airfoil, wherein the three first locations are defined in a region between 20% and 100% of a span length of the span, and wherein the span length is defined from the base to the tip along a stacking axis.

3. The blade of claim 2, wherein the three first locations are defined at 30%, 70%, and 100% of the span length.

4. The blade of claim 2, wherein the one or more second locations are defined in a region between 35% and 65% of the span length.

5. The blade of claim 1, wherein the chord length at the one or more first locations and the maximum thickness at the one or more second locations are determined to move at least two modal responses of the blade outside of a desired operating range of the gas turbine engine.

6. The blade of claim 1, wherein the chord length at the one or more first locations and the maximum thickness at the one or more second locations are determined to maximize a separation of at least two modal responses of the blade, and wherein the at least two modal responses of the blade are defined proximal to a desired operating range of the gas turbine engine.

7. The blade of claim 1, wherein the maximum thickness at the one or more second locations is offset from a stacking axis defined by the airfoil, and wherein the stacking axis extends along the span of the airfoil and extends centrally relative to the leading edge and the trailing edge.

8. The blade of claim 1, wherein the blade is made of stainless steel.

9. The blade of claim 1, wherein the blade includes an anti-corrosion coating.

10. A compressor assembly for a gas turbine engine, the compressor assembly comprising:
a central hub; and
a plurality of blades coupled with and extending radially from the central hub, wherein each of the plurality of blades includes:
an airfoil including a leading edge, a trailing edge, a suction surface, a pressure surface, a base, and a tip, wherein the airfoil defines:
a chordal axis of the airfoil between the leading edge and the trailing edge;
a span of the airfoil between the base and the tip;
a chord length of the airfoil along the chordal axis, wherein the chord length of the airfoil varies along the span of the airfoil, wherein the chord length at one or more first locations of the airfoil is less than the chord length defined at the base of the airfoil, and wherein the one or more first locations of the airfoil are spaced apart from each other along the span of the airfoil; and
a maximum thickness of the airfoil between the suction surface and the pressure surface, wherein the maximum thickness of the airfoil varies along each of the span of the airfoil and the chordal axis of the airfoil, wherein the maximum thickness at one or more second locations of the airfoil is greater than the maximum thickness defined at the tip of the airfoil, and wherein the one or more second locations of the airfoil are spaced apart from each other along the span of the airfoil.

11. The compressor assembly of claim 10, wherein the chord lengths at three first locations of the airfoil is less than the chord length defined at the base of the airfoil, wherein the three first locations are defined in a region between 20% and 100% of a span length of the span, and wherein the span length is defined from the base to the tip along a stacking axis.

12. The compressor assembly of claim 11, wherein the three first locations are defined at 30%, 70%, and 100% of the span length of the span.

13. The compressor assembly of claim 11, wherein the one or more second locations are defined in a region between 35% and 65% of the span length of the span.

14. The compressor assembly of claim 10, wherein the chord length at the one or more first locations and the maximum thickness at the one or more second locations are determined to move at least two modal responses of the blade outside of a desired operating range of the gas turbine engine.

15. The compressor assembly of claim 10, wherein the chord length at the one or more first locations and the maximum thickness at the one or more second locations are determined to maximize a separation of at least two modal responses of the blade, and wherein the at least two modal responses of the blade are defined proximal to a desired operating range of the gas turbine engine.

16. The compressor assembly of claim 10, wherein the maximum thickness at the one or more second locations is offset from a stacking axis defined by the airfoil, and wherein the stacking axis extends along the span of the airfoil and extends centrally relative to the leading edge and the trailing edge.

17. A method of altering a modal response of a blade for a compressor assembly of a gas turbine engine, the blade including an airfoil including a leading edge, a trailing edge, a suction surface, a pressure surface, a base, and a tip, the airfoil defining a chordal axis of the airfoil between the leading edge and the trailing edge, a span of the airfoil between the base and the tip, a chord length of the airfoil along the chordal axis, and a maximum thickness of the airfoil between the suction surface and the pressure surface, the method comprising:
detecting a failure of the blade due to the modal response of the blade;
tuning the chord length of the airfoil, wherein, based on the tuning of the chord length, the chord length varies along the span of the airfoil, wherein, based on the tuning of the chord length, the chord length at one or more first locations of the airfoil is less than the chord length defined at the base of the airfoil, and wherein the one or more first locations of the airfoil are spaced apart from each other along the span of the airfoil; and
tuning the maximum thickness of the airfoil, wherein, based on the tuning of the maximum thickness, the maximum thickness varies along each of the span of the airfoil and the chordal axis of the airfoil, wherein, based on the tuning of the maximum thickness, the maximum thickness at one or more second locations of the airfoil is greater than the maximum thickness defined at the tip of the airfoil, and wherein the one or more second locations of the airfoil are spaced apart from each other along the span of the airfoil; and
altering the modal response of the blade based on the tuning of the chord length and the maximum thickness.

18. The method of claim 17, wherein the step of tuning the chord length of the airfoil further includes tuning the chord lengths at three first locations of the airfoil, such that the chord length at the three first locations is less than the chord length defined at the base of the airfoil, wherein the three first locations are defined in a region between 20% and 100% of a span length of the span, and wherein the span length is defined from the base to the tip along a stacking axis.

19. The method of claim 17 further comprising:
determining the chord length at the one or more first locations and the maximum thickness at the one or more second locations to move at least two modal responses of the blade outside of a desired operating range of the gas turbine engine.

20. The method of claim 17 further comprising:
determining the chord length at the one or more first locations and the maximum thickness at the one or more second locations to maximize a separation of at least two modal responses of the blade, wherein the at least two modal responses of the blade are defined proximal to a desired operating range of the gas turbine engine.
